(19) United States
(12) Patent Application Publication
(10) Pub. No.: US 2020/0097154 A1
(43) Pub. Date: Mar. 26, 2020

(54) Slicer Tool

(71) Applicant: Intuitive Research and Technology Corporation, Huntsville, AL (US)

(72) Inventors: Chanler Crowe, Madison, AL (US); Kyle Russell, Huntsville, AL (US); Michael Jones, Athens, AL (US); Michael Yohe, Meridianville, AL (US)

(21) Appl. No.: 16/204,273

(22) Filed: Nov. 29, 2018

Related U.S. Application Data
(60) Provisional application No. 62/733,798, filed on Sep. 20, 2018.

(51) Int. Cl. G06F 3/0481; G06T 17/20; G06T 19/20; G06T 15/20; G06F 3/033

(52) U.S. Cl. CPC G06F 3/04815; G06T 17/20; G06T 19/20; G06T 2219/2016; G06F 3/033; G06T 2219/2008; G06T 15/20

(57) ABSTRACT

A computer-implemented visualization method allows the displaying of three-dimensional mesh to the user, including the manipulation of the mesh. The system allows a virtual tool that to virtually manipulate a generated three-dimensional procedural mesh object by cutting through the mesh, viewing within the mesh, and then reconnecting the mesh at runtime.

### REFERENCE TO RELATED APPLICATIONS

This application claims priority to Provisional Patent Application U.S. Ser. No. 62/733,798, entitled “Slicer Tool” and filed on Sep. 20, 2018, which is fully incorporated herein by reference.

### BACKGROUND AND SUMMARY

Traditionally, virtual three-dimensional meshes require use of a third-party software to break the mesh into pieces before the pieces of the mesh can be manipulated and separated at runtime. This breaking apart of the mesh is traditionally done using a separate three-dimensional modeling program that allows the user to separate the mesh into a multitude of pieces either by hand or by built-in functionality of the software. Depending on the complexity of the mesh this process of breaking the mesh into pieces can be very time consuming and tedious work. Once the mesh is broken apart, the mesh must then be exported into a file format that can be imported into a virtual environment. Once exported from the three-dimensional modeling software, the files must then be imported into the virtual environment to facilitate manipulation of the mesh at runtime.

Various techniques have been used to manipulate mesh objects within virtual worlds. Generally, they are manipulated outside of the virtual world, then imported into the virtual world. This drastically limits the user's ability to manipulate the mesh in runtime.

Presented herein are methods, systems, and devices describing systems and techniques by which users of a computer-implemented visualization method may manipulate three-dimensional mesh objects. These objects may be virtual representations of real-life objects represented in the virtual world that highlight characteristics of the real-life objects. The mesh may be generated by models or by digital data.

Once the mesh is imported into the virtual world, the user may use the described invention to manipulate the mesh. The user may grab the virtual plane slicer and place it within the mesh. The slicer plane contains a virtual camera that displays upon a plane in XR. The camera's view is updated in real time as the slicer plane is moved and manipulated. When the slicer plane intersects the mesh, it will show the slicer plane's view of the interior of the mesh. The user may also change the camera view to display the view of the opposite side of the slicer plane by pressing a button on the input device.

If the user would like to separate the mesh, the user may then press a button and the tool will cut the mesh along the plane of the tool. After the mesh has been separated, the user may manipulate or view the mesh as needed. The mesh may then be cut again as necessary. The user may reassemble the mesh by pressing a button on the controller.

### BRIEF DESCRIPTION OF THE DRAWINGS

The disclosure can be better understood with reference to the following drawings. The elements of the drawings are not necessarily to scale, emphasis instead being placed upon clearly illustrating the principles of the disclosure. Furthermore, like reference numerals designate corresponding parts throughout the several views.

FIG. 1 is a flow diagram depicting a system for using a tool to manipulate three-dimensional model according to the present disclosure.

FIG. 2 is a flow diagram depicting the representation of data in three-dimensional space.

FIG. 3 is a flow diagram depicting the method of preparing the virtual slice plane to interact with and manipulate three-dimensional model.

FIG. 4 is a flow diagram depicting the method of using the virtual slice plane to cut a three-dimensional model.

FIG. 5 is a flow diagram depicting the method of displaying the virtual slice plane's camera to place the slice tool.

FIG. 6 is a flow diagram depicting controlling the view of the virtual slice plane's camera to view the three-dimensional model.

FIG. 7 is a flow diagram depicting the use of the slice plane to manipulate a three-dimensional model.

FIG. 8 is a visual representation of a three-dimensional model, the slice plane, and input devices, represented by controllers in this embodiment.

FIG. 9 is a visual representation of the input device, in this embodiment a controller, manipulating the slice plane by moving it.

FIG. 10 is a visual representation of the intersection of the slice plane intersecting with a three-dimensional mesh, represented by a sphere.

FIG. 11 is a visual representation of the manipulation of a cut three-dimensional mesh, represented in this embodiment by two halves of a sphere.

FIG. 12 is a visual representation of the separation of a three-dimensional mesh, represented in this embodiment by a sphere separated into two halves.

FIG. 13 is a visual representation of the recombination of a three-dimensional mesh, represented in this embodiment by two halves of a sphere being restored into one whole sphere.

FIG. 14 is a visual representation of the visualization method of the virtual slice tool.

FIG. 15 is a visual representation of the capabilities of the virtual slice tool to project the interior of multiple directions of the interior of a three-dimensional mesh.

FIG. 16 is a visual representation of the ability of the user to change the view of the camera showing the interior of the three-dimensional mesh.

### DETAILED DESCRIPTION

In some embodiments of the present disclosure, the operator may use a virtual controller to manipulate three-dimensional mesh. As used herein, the term “XR” is used to describe Virtual Reality, Augmented Reality, or Mixed Reality displays and associated software-based environments. As used herein, “mesh” is used to describe a three-dimensional object in a virtual world, including, but not limited to, systems, assemblies, subassemblies, cabling, piping, landscapes, avatars, molecules, proteins, ligands, or chemical compounds.

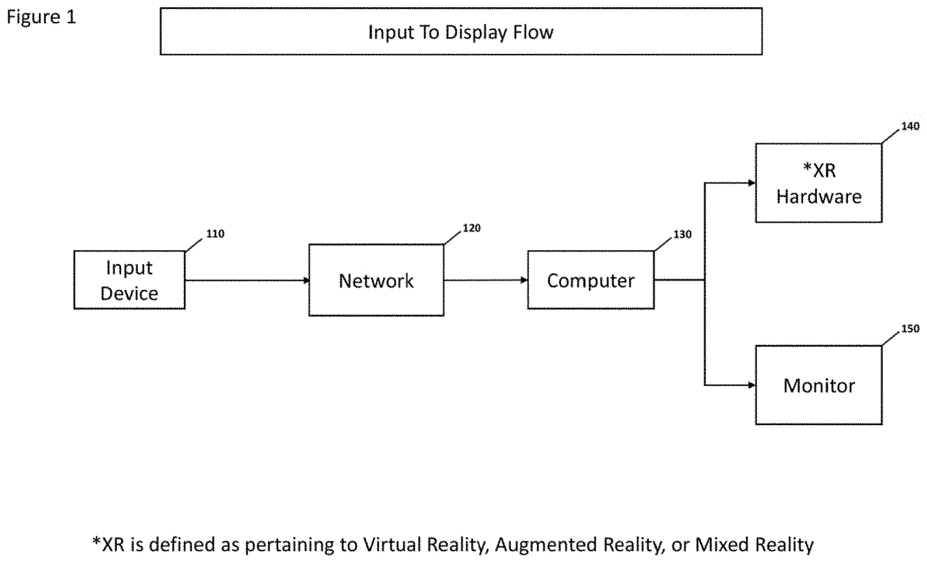

FIG. 1 depicts a system 100 for slicing a three-dimensional model (not shown), according to an exemplary embodiment of the present disclosure. The system 100 comprises an input device 110 communicating across a network 120 to a computer 130. The input device 110 may comprise, for example, a keyboard, a switch, a mouse, a joystick, a touch pad and/or other type of interface, which can be used to input data from a user of the system 100. The network 120 may be of any type network or networks known in the art or future-developed, such as the internet backbone, Ethernet, Wifi, WiMax, and the like. The network 120 may be any combination of hardware, software, or both. XR hardware 140 comprises virtual or mixed reality hardware that can be used to visualize a three-dimensional world. A video monitor 150 is used to display the Object to the user. The input device 110 receives input from the processor 130 and translates that input into an XR setting. The input device 110 allows a user to input data to the system 100, by translating user commands into computer commands.

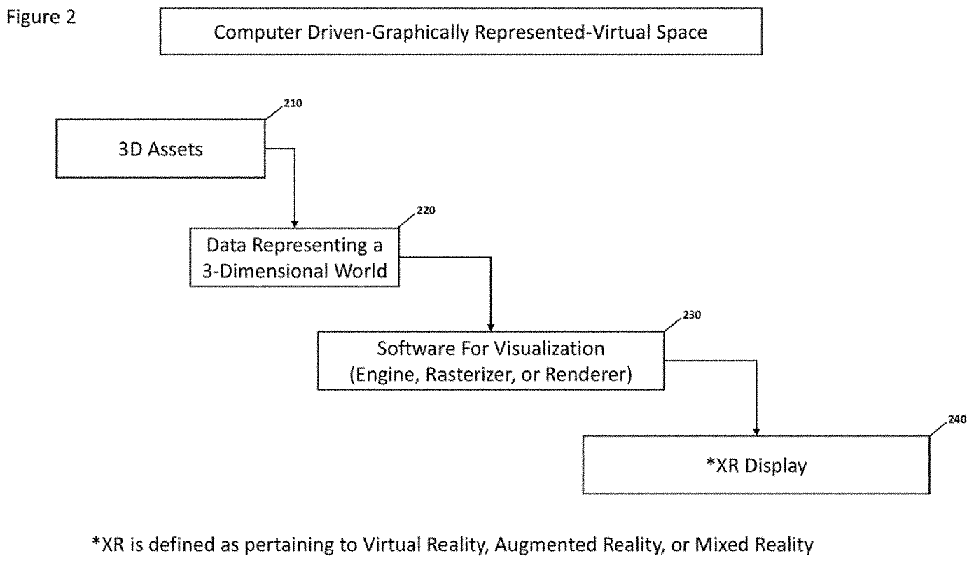

FIG. 2 illustrates the relationship between three-dimensional assets, the data representing those assets, and the communication between that data and the software, which leads to the representation on the XR platform. Three-dimensional assets 210 may be any three-dimensional assets, which are any set of points that define geometry in three-dimensional space.

The data representing a three-dimensional world 220 is a procedural mesh that may be generated by importing three-dimensional models, images representing two-dimensional data, or other data converted into a three-dimensional format. The software for visualization 230 of the data representing a three-dimensional world 220 allows for the processor 130 (FIG. 1) to facilitate the visualization of the data representing a three-dimensional world 220 to be depicted as three-dimensional assets 210 in the XR display 240.

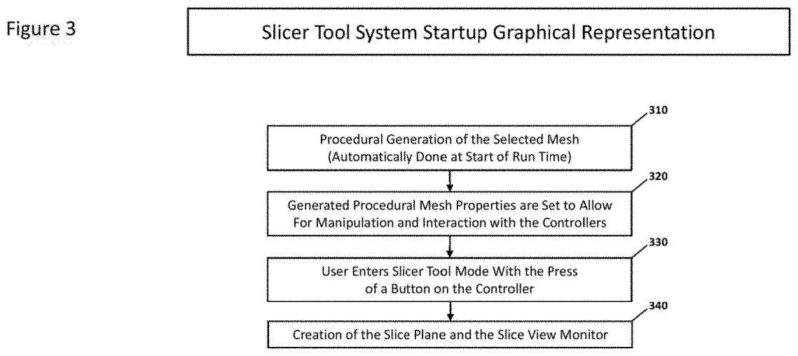

FIG. 3 depicts an exemplary process 300 of the slice plane tool system startup. The generation of the three-dimensional model, in this embodiment a procedural mesh, is initiated in step 310. This is automatically done at the start of run time. In step 320, the three-dimensional model's properties are set to allow for manipulation and generation with input devices, in this embodiment controllers. In step 330, the user then enters the slice tool mode by pressing a button on the input device, in this embodiment a controller. In step 340, the processor 130 (FIG. 1) generates the slice plane and slice plane view monitor from the algorithm created and saves it for mesh manipulation in the three-dimensional level in the software.

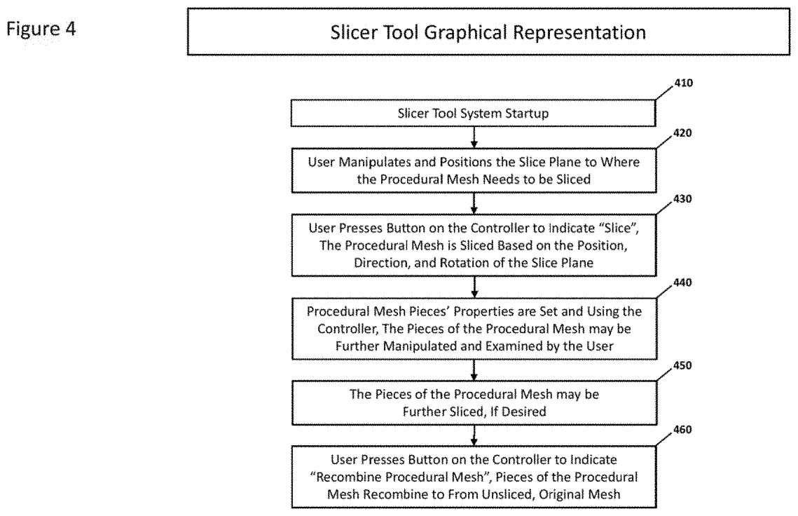

FIG. 4 depicts an exemplary method 400 of the use of the slice plane to slice, manipulate, and recombine three-dimensional models, in this embodiment, a procedural mesh. The process begins with the slice tool system startup method 300, which was discussed with respect to FIG. 3 herein. In step 420, the user manipulates and places the slice plane, using the controller. The user may place the slice plane anywhere within the mesh. In step 430, once the user has placed the slice plane and pushes a button on the controller, the slice plane will cut the mesh along the slice plane. In step 440, once the mesh is sliced, it may be separated, manipulated, and examined by the user. In step 450, the mesh may be sliced again, at the user's discretion. In step 460, the user then may recombine the mesh, by pressing a button on the controller, recombining the mesh will reverse the slice and recombine the mesh.

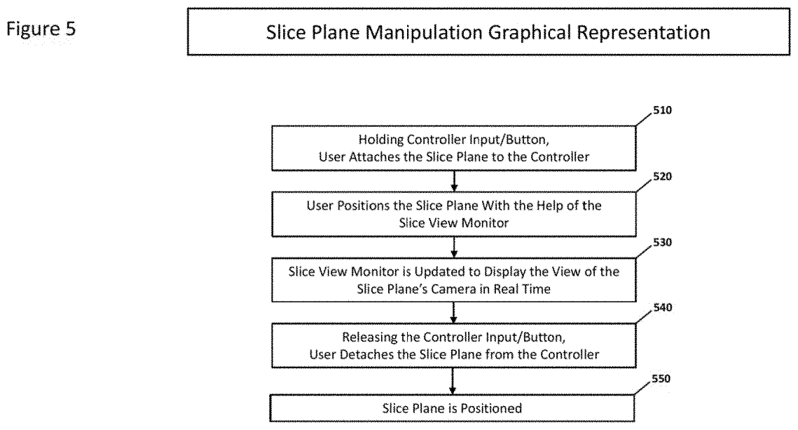

FIG. 5 depicts an exemplary method 500 for using the input device, in this embodiment a controller, to use the slice plane's camera to display the interior of a three-dimensional model, in this embodiment a procedural mesh. In step 510, the user “attaches” the slice plane to the controller by holding the controller input/button. The user then in step 520 uses the controller to position the slice plane within the mesh, i.e., intersecting with the mesh, by using the view projected onto the slice view monitor. In step 530, the slice view monitor updates in real time to display the interior of the three-dimensional model. In step 540, after releasing the button of the input device, the user can “detach” the slice plane from the controller, which was attached in step 510. Once the user detaches the slice plane from the controller, in step 550, the slice plane is placed.

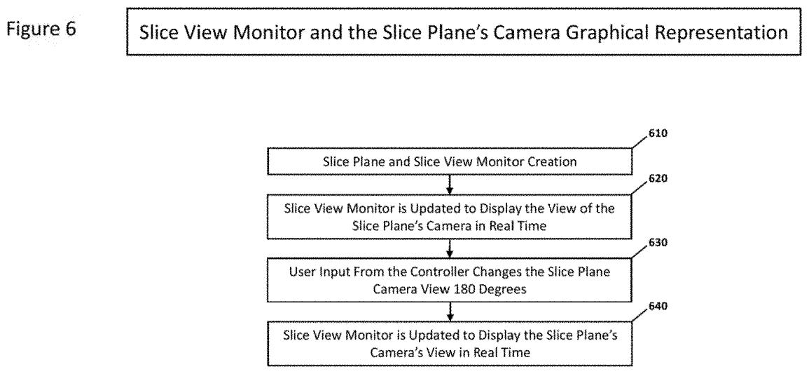

FIG. 6 depicts a method 600 of using of the slice plane camera to display the interior of a three-dimensional model onto the slice view monitor. In step 610, the slice plane and slice view monitor are created using the method 300 of FIG. 3. In step 620, internal virtual camera updates the slice view monitor on the game time tick by the time tick automatically rendering the slice view monitor to display the interior of the three-dimensional model in real time. In step 630, the user may change the view of the slice plane's camera from one side of the slice to the other (i.e., 180 degrees) by pressing a button on the controller. If the user changes the view of the slice plane's camera in step 630, in step 640 the internal virtual camera updates the slice view monitor in real time to change the display on the slice view monitor.

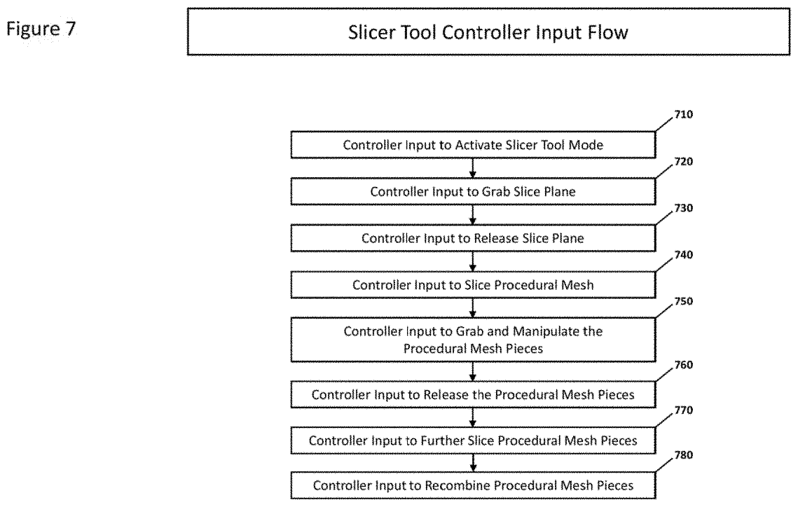

FIG. 7 illustrates an exemplary process 700 of using the slice plane to manipulate a three-dimensional model, in this embodiment a procedural mesh. In step 710, the user activates the slice plane tool via the input device, in this embodiment a controller. In step 720, the user may grab the slice plane by pressing and holding a button on the input device. In step 730, the user may release the slice plane by releasing the button on the input device. In step 740, if the user has grabbed the slice plane, as in 720, and placed the slice plane (FIG. 4), then the user may use the slice tool to cut the three-dimensional model, in this embodiment a procedural mesh. In step 750, the user may use the input device to grab the slice plane and manipulate the pieces of the mesh. In step 760, the user may use the input device to release the three-dimensional model, in this embodiment a procedural mesh, by pressing a button on the input device. In step 770, the user may use the input device, the ability to grab the slice plane (per step 720), release the slice plane (per step 730), and slice the object (per step 740), to further slice procedural mesh pieces. In step 780, the user may use the input device to recombine the three-dimensional model by pressing a button to restore the three-dimensional model to the state it was in before it was sliced.

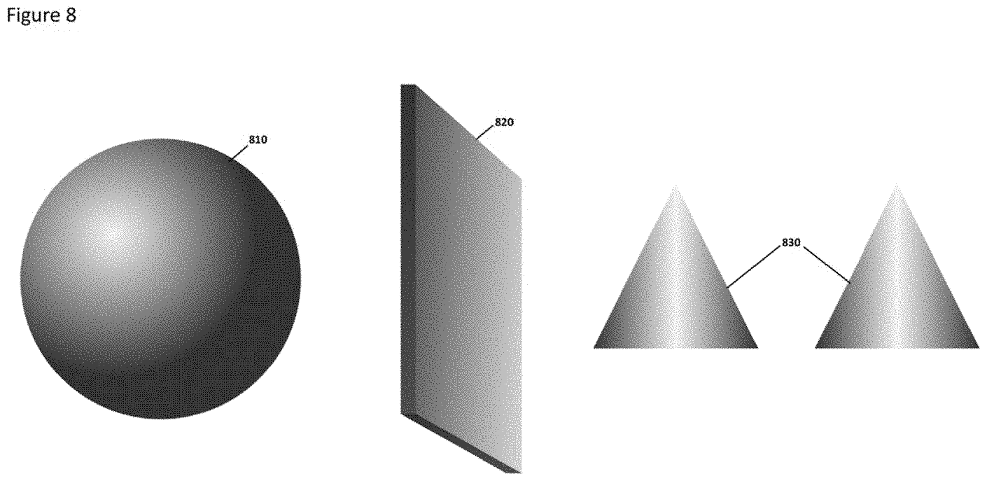

FIG. 8 is a visual representation of an exemplary slicer tool 820 and an exemplary mesh 810. The slicer tool 820 is represented as a plane in this figure. The mesh 810 is represented by a sphere in this figure, though could be any three-dimensional shape. The slicer tool 820 may be controlled by one or more input devices 830, which may comprise, for example, a keyboard, a switch, a mouse, a joystick, a touch pad and/or other type of interface, which can be used to input data from a user of the system 100 (FIG. 1) to manipulate the mesh 810. The input device 830 is represented as two triangles in FIG. 8. In one embodiment, the user has two controllers, one for each hand, which makes the manipulation of the slicer tool efficient. In other embodiments one controller may be used.

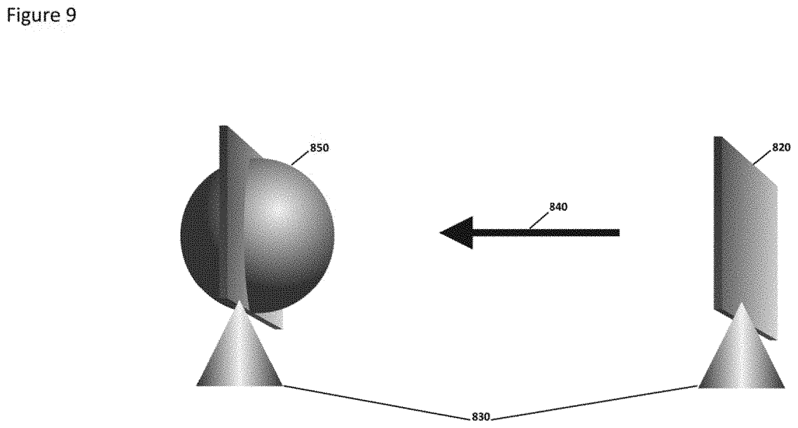

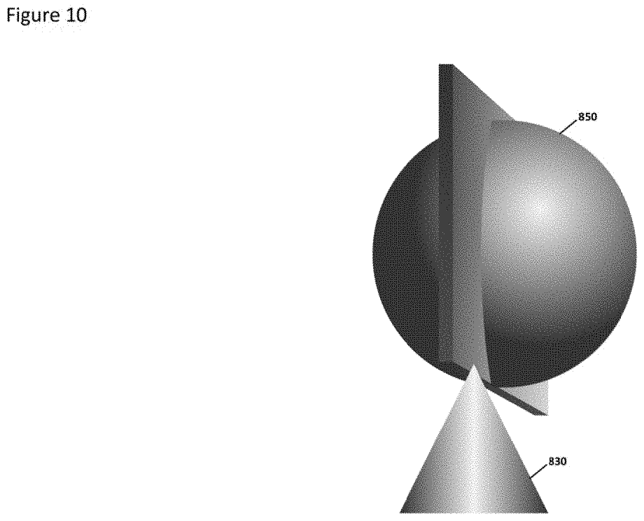

FIG. 9 visually represents the controller 830 attached to the slice tool 820, for moving the slice tool 820 inside of a mesh 850 (FIG. 10).

FIG. 10 represents the combination of the slice tool 820, moved by the input device 830 to within the mesh 850, as if they were one object.

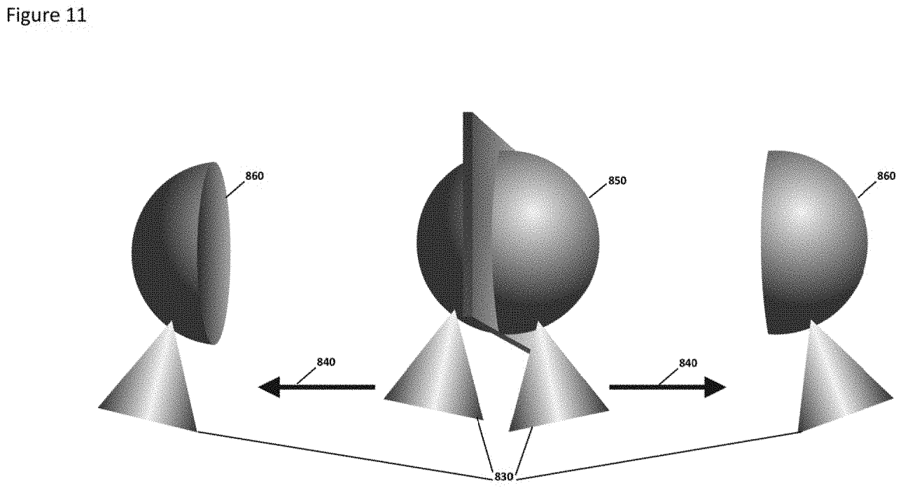

FIG. 11 demonstrates the user's ability to move 840 the input device 830 to cut and manipulate the mesh from one piece 850 into multiple pieces 860.

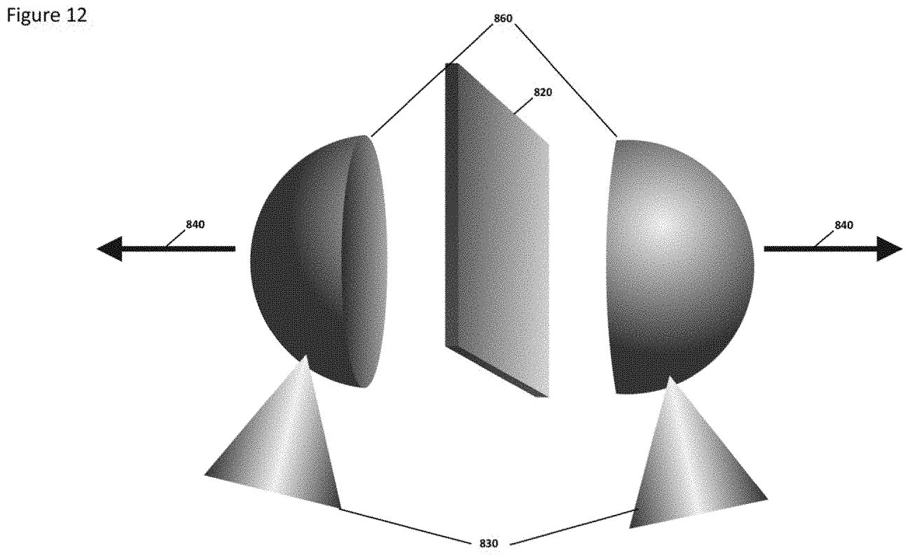

FIG. 12 illustrates the slice tool 820 between two sliced halves 860 of a mesh.

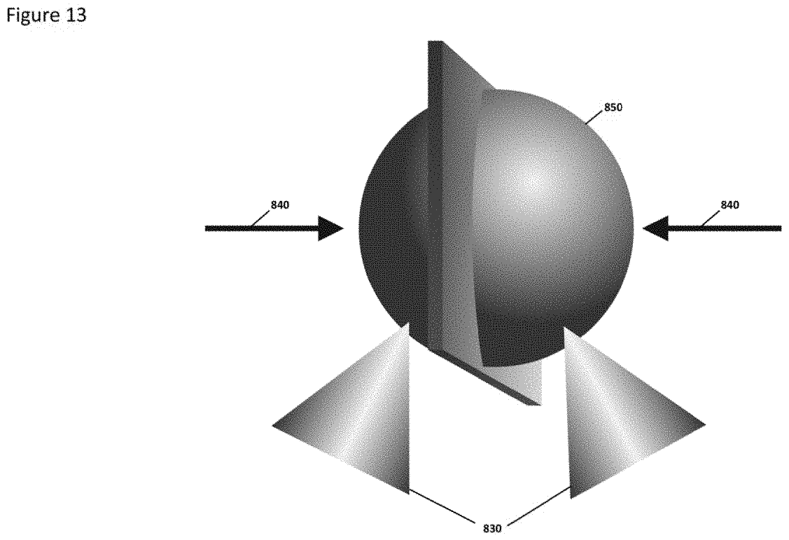

FIG. 13 demonstrates the user's ability to use the input devices 830 to move 840 the mesh 850 back together using the slice tool 820.

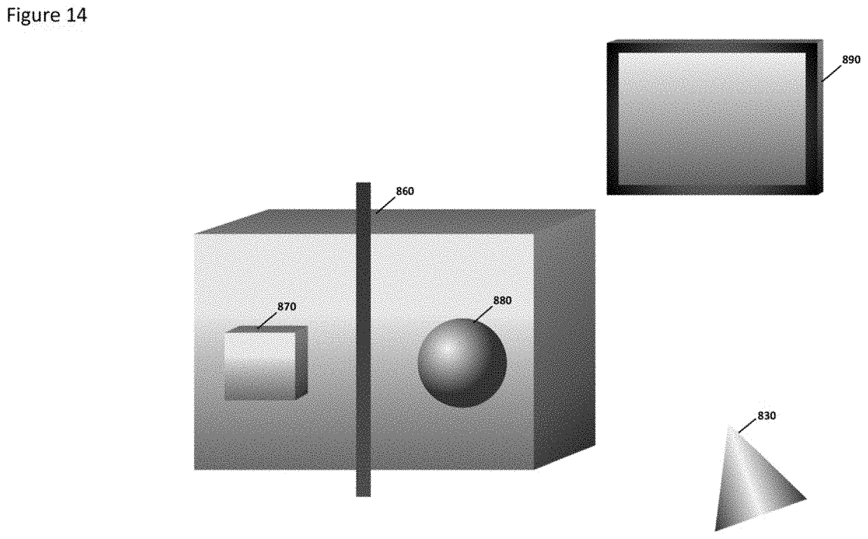

FIG. 14 illustrates the user's ability to use the input device 830 to project one side of a mesh onto a plane 890 within XR. In this regard, a large, hollow, rectangular mesh 895 contains a cube 870 on a left side and a sphere 880 on a right side. In virtual reality, a user would not be able to see the two interior meshes 870 and 880 because they are completely encompassed by the larger mesh. A slice plane 860 intersects the middle of the rectangular mesh 895. A slice plane window 890 illustrates the camera view from the slice plane, i.e., the interior of the rectangular mesh. The slice plane window 890 in FIG. 14 is shown as blank.

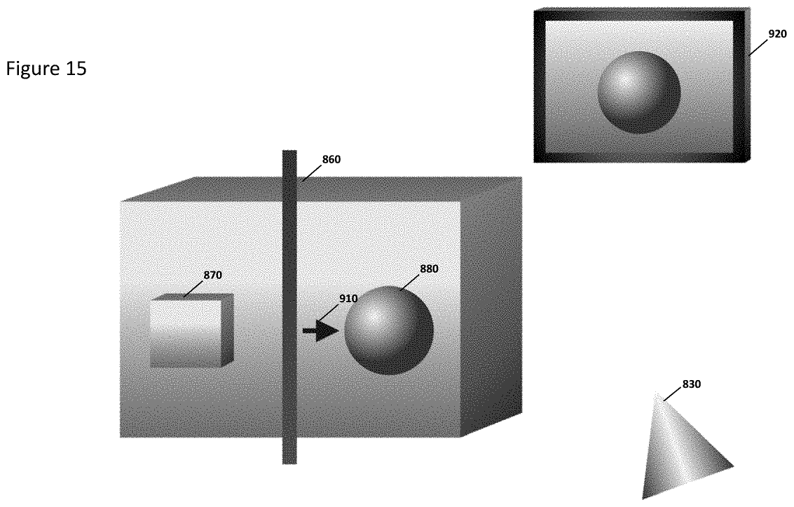

FIG. 15 depicts the mesh 895 of FIG. 14, with the virtual camera 910 facing to the right. The slice plane window 890 now shows a view of the sphere mesh 880 as seen from the slice plane 860 looking right.

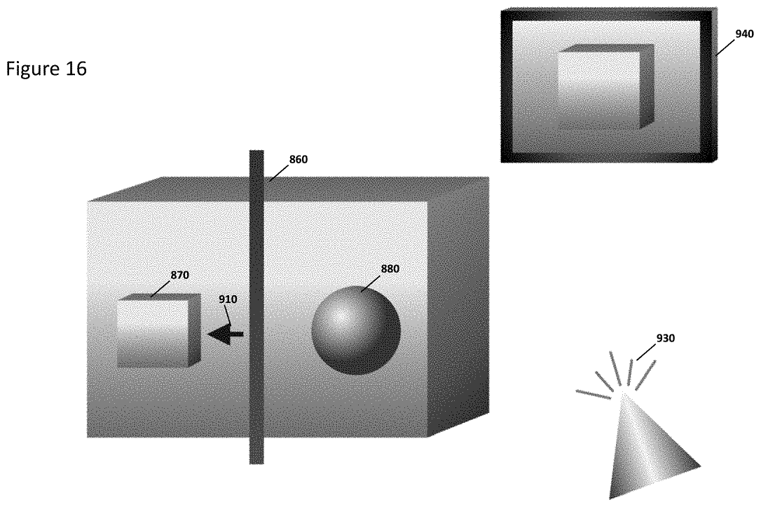

FIG. 16 depicts the mesh 895 of FIG. 14, with the virtual camera 910 facing to the left. The slice plane window 890 now depicts the cube mesh 870 as seen from the slice plane 860 looking left. In FIG. 16, therefore, the camera view has been “switched” from one side of the mesh 895 to the other side, which is done by the user pressing a button on the input device 930.

What is claimed is:

1. A computer-implemented virtual visualization method, comprising:
identifying a three-dimensional procedural mesh;
generating a virtual representation of a slicing plane tool, the slicing plane tool configured to virtually slice the mesh;
moving the virtual representation of the slicing plane tool to intersect with the mesh;
viewing a plane of an interior of the mesh using a camera feature of the slicing plane tool;
cutting along the intersection of the slicing plane tool and the mesh to form cut pieces of the mesh;
separating the cut pieces of the mesh;
displaying the cut pieces of the mesh.

2. The method of claim 1, wherein the step of moving the virtual representation of the slicing plane tool to intersect with the mesh further comprises attaching the controller to the slicing plane tool and manipulating the controller to move the virtual representation of the slicing plane tool.

3. The method of claim 1, further comprising restoring the mesh to make it whole.

4. The method of claim 1, wherein the slicing plane tool is a clear, flat plane moveable anywhere in virtual space.

5. The method of claim 1, further comprising moving the cut pieces of the mesh.

6. The method of claim 5, further comprising rotating the cut pieces of the mesh.

7. The method of claim 6, further comprising rearranging the cut pieces of the mesh.

8. The method of claim 1, where the user may view one side of the mesh prior to cutting the mesh.

9. The method of claim 1, where the user may use the controller to switch the view of the camera from viewing one side of the plane to view an opposed side of the plane.

10. The method of claim 1, further comprising slicing the mesh anywhere in virtual space at runtime.

11. The method of claim 1, where the step of cutting along the intersection of the slicing plane tool and the mesh to form cut pieces of the mesh is performed by selecting a button on the controller that automates a “slice” function.

12. A computer-implemented virtual visualization method, comprising:
identifying a three-dimensional procedural mesh;
generating a slicing plane tool, the slicing plane tool configured to virtually slice the mesh;
slicing the mesh with the slicing plane tool to form sliced mesh parts;
separating the sliced mesh parts from the mesh;
displaying the sliced parts of the mesh.

13. The method of claim 12, wherein the step of viewing a plane of a sliced interior of the mesh uses a camera feature of the slicing plane tool.

14. The method of claim 13, further comprising restoring the mesh to make the mesh whole.
